(19) United States
(12) Patent Application Publication
(10) Pub. No.: US 2026/0104377 A1
(43) Pub. Date: Apr. 16, 2026

(54) TIRE OUTER-DAMAGE MONITORING DEVICE, AND TIRE OUTER-DAMAGE MONITORING METHOD

(71) Applicant: BRIDGESTONE CORPORATION, Chuo-ku, Tokyo (JP)

(72) Inventor: Hiroyuki KATSUNO, Chuo-ku, Tokyo (JP)

(73) Assignee: BRIDGESTONE CORPORATION, Chuo-ku, Tokyo (JP)

(21) Appl. No.: 19/117,200

(22) PCT Filed: Nov. 24, 2023
(86) PCT No.: PCT/JP2023/042245

§ 371 Date: Mar. 31, 2025

(30) Foreign Application Priority Data
Dec. 26, 2022 (JP) 2022-208930

(51) Int. Cl. G01N 25/72; G06T 7/00; G06T 7/50

(52) U.S. Cl. CPC G01N 25/72; G06T 7/0002; G06T 7/50; G06T 2207/10048

(57) ABSTRACT

The tire outer-damage monitoring device of the present disclosure acquires an image of a tire; quantifies a degree of outer-damage on an outer surface of the tire as captured in the image; determines whether the degree of the outer-damage is outside a tolerance range of durability of the tire; and on determining the degree of the outer-damage is outside the tolerance range, outputs outer-damage information on the tire.

TECHNICAL FIELD

The present disclosure relates to a tire outer-damage monitoring device and a tire outer-damage monitoring method.

### BACKGROUND

Technology for monitoring tire outer-damage is known. For example, Patent Literature (PTL) 1 describes a tire outer-damage detection system that detects size of an outer-damage portion of a tire relative to diameter of the rim wheel, based on image data of the tire mounted on the rim wheel.

### CITATION LIST

### Patent Literature

PTL 1: JP 2019-202729 A

### SUMMARY

### Technical Problem

However, there is a need to further improve the usefulness of the technology for monitoring tire outer-damage. For example, in mine vehicles used at mine sites, when sudden tire failure occurs, productivity is decreased due to the need to perform work such as transporting the mine vehicle and changing the tire. Further, inspection of tires by workers to prevent sudden failure is a cost burden. Therefore, there is a need to automate the monitoring of tire outer-damage.

In view of such circumstances, it would be helpful to provide a tire outer-damage monitoring device and a tire outer-damage monitoring method that improve the usefulness of the technology for monitoring tire outer-damage.

### Solution to Problem

[1] A tire outer-damage monitoring device according to an embodiment of the present disclosure comprises a controller configured to execute: acquiring an image of a tire; quantifying a degree of outer-damage on an outer surface of the tire as captured in the image; determining whether the degree of the outer-damage is outside a tolerance range of durability of the tire; and on determining the degree of the outer-damage is outside the tolerance range, outputting outer-damage information on the tire.
[2] The tire outer-damage monitoring device according to an embodiment of the present disclosure is the tire outer-damage monitoring device according to [1], above, wherein preferably, the quantifying of the degree of the outer-damage includes estimating depth of the outer-damage from at least one of length or width of the outer-damage on the outer surface of the tire as captured in the image.
[3] The tire outer-damage monitoring device according to an embodiment of the present disclosure is the tire outer-damage monitoring device according to [1] or [2], above, wherein preferably, the image includes a thermographic image captured by a thermographic camera, and the quantifying of the degree of the outer-damage includes estimating depth of the outer-damage from temperature of the outer-damage on the outer surface of the tire as captured in the thermographic image.
[4] The tire outer-damage monitoring device according to an embodiment of the present disclosure is the tire outer-damage monitoring device according to [3], above, wherein preferably, the controller is configured to further execute: acquiring cavity temperature of the tire; and estimating the depth of the outer damage using the cavity temperature of the tire in addition to the temperature of the outer-damage on the outer surface of the tire as captured in the image.
[5] The tire outer-damage monitoring device according to an embodiment of the present disclosure is the tire outer-damage monitoring device according to any one of [1] to [4], above, wherein preferably, the controller is further configured to execute: acquiring running distance or running time of a vehicle on which the tire is mounted; and determining whether the degree of the outer-damage is outside the tolerance range of the durability of the tire based on the degree of the outer-damage and the running distance or running time of the vehicle, wherein the tolerance range is set such that the greater the degree of the outer-damage and the less the running distance or the travel time of the vehicle, the more likely the degree of the outer-damage exceeds the tolerance range.
[6] The tire outer-damage monitoring device according to an embodiment of the present disclosure is the tire outer-damage monitoring device according to any one of [1] to [4], above, wherein preferably, the controller is further configured to execute: acquiring thermal history of the tire; and determining whether the degree of the outer-damage is outside the tolerance range of the durability of the tire based on the degree of the outer-damage and the thermal history of the tire, wherein the tolerance range is set such that the greater the degree of the outer-damage and the greater the thermal history, the more likely the degree of the outer-damage exceeds the tolerance range.
[7] The tire outer-damage monitoring device according to an embodiment of the present disclosure is the tire outer-damage monitoring device according to any one of [1] to [6], above, wherein preferably, the image of the tire includes a first image captured under severe conditions putting a large load on the tire and a second image captured under mild conditions putting a small load on the tire, and the controller is configured to execute: determining whether the degree of the outer-damage of the tire is outside the tolerance range of the durability of the tire based on a first degree of outer-damage quantified based on the first image and a second degree of outer-damage quantified based on the second image.
[8] A tire outer-damage monitoring method according to an embodiment of the present disclosure is a method of monitoring tire outer-damage executed by one or more computers, the tire outer-damage monitoring method comprising: acquiring an image of a tire; quantifying a degree of outer-damage on an outer surface of the tire as captured in the image; determining whether the degree of the outer-damage is outside a tolerance range of durability of the tire; and on determining the degree of the outer-damage is outside the tolerance range, outputting outer-damage information on the tire.

### Advantageous Effect

According to the present disclosure, the tire outer-damage monitoring device and the tire outer-damage monitoring method can be provided that can improve the usefulness of the technology for monitoring tire outer-damage.

### BRIEF DESCRIPTION OF THE DRAWINGS

In the accompanying drawings:

FIG. 1 is a diagram schematically illustrating a tire outer-damage monitoring system according to an embodiment of the present disclosure;

FIG. 2 is a block diagram illustrating the server illustrated in FIG. 1;

FIG. 3 is a flowchart illustrating operation of the tire outer-damage monitoring system illustrated in FIG. 1; and

FIG. 4 is a diagram illustrating an example of an image of a tire.

### DETAILED DESCRIPTION

The following is a description of a tire outer-damage monitoring system according to an embodiment of the present disclosure, with reference to the drawings. Members and sites common to each drawing are marked with the same reference signs. However, the drawings are schematic and dimensions, ratios, and the like may differ from actual implementation.

### Configuration of Tire Outer-Damage Monitoring System

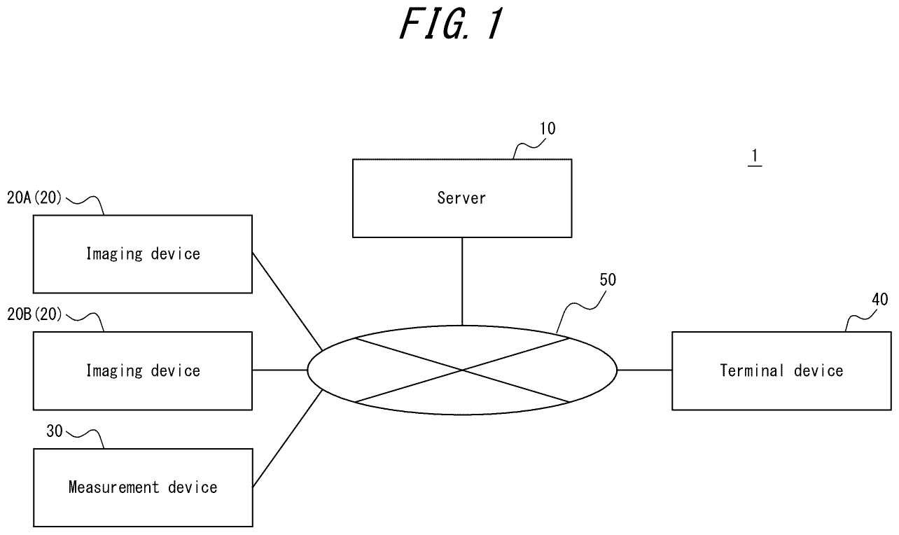

First, an overview of the tire outer-damage monitoring system 1 according to the present embodiment is described, with reference to FIG. 1. FIG. 1 is a diagram schematically illustrating the tire outer-damage monitoring system 1. As illustrated in FIG. 1, the tire outer-damage monitoring system 1 includes a server 10, imaging devices 20A and 20B, a measurement device 30, and a terminal device 40. In the following description, when the imaging devices 20A and 20B are not specifically distinguished, they may be referred to simply as imaging devices 20 or individually as imaging device 20. In FIG. 1, one of each of the server 10, the measurement device 30, and the terminal device 40, and two of the imaging devices 20A, 20B are illustrated. However, the tire outer-damage monitoring system 1 may include any number of the server 10, the imaging devices 20, the measurement device 30, and the terminal device 40.

The server 10 comprises one or more computers. According to the present embodiment, the server 10 is described as comprising a single computer. However, the server 10 may comprise a plurality of computers, such as a cloud computing system or the like. In the present disclosure, the server 10 is also referred to as a “tire outer-damage monitoring device”.

The imaging devices 20 comprise a computer that includes one or more cameras. Each camera may be any camera capable of capturing an image, such as a thermographic camera, a visible light camera, an infrared camera, or the like. According to the present embodiment, the imaging devices 20 include a thermographic camera and a visible light camera, as an example. An image captured by the imaging device 20 may be a still image, such as a photograph, and may be a moving image. The imaging device 20 generates an image of the tire 2 and transmits to the server 10. The image of the tire 2 captures at least a portion of the tire 2. In addition to at least a portion of the tire 2, the image of the tire 2 may also capture at least a portion of a vehicle 3 on which the tire 2 is mounted.

The imaging device 20 may be, for example, the imaging device 20 that is fixed and installed in a travel path of the vehicle 3 at a mine site. This allows the imaging device 20 to capture an image of the vehicle 3 while on the travel path, which is less likely to decrease the availability of the vehicle 3 and productivity in the mine. According to the present embodiment, the imaging device 20A is disposed on the travel path of the vehicle 3 at a mine site at a point of severe conditions putting a large load on the tire 2 mounted on the vehicle 3. Severe conditions are, for example, when the vehicle 3 is fully loaded and climbing a hill. On the other hand, the imaging device 20B is disposed on the travel path of the vehicle 3 at the mine site at a point of mild conditions putting a small load on the tire 2 mounted on the vehicle 3. Mild conditions are, for example, when the vehicle 3 is unloaded and traveling on a flat road. However, the severe conditions and the mild conditions may be arbitrarily determined so that the severe conditions put a greater load on the tire 2 than the mild conditions. Further, the imaging device 20 is not limited to being a fixed imaging device 20, and may be a movable imaging device 20, such as the imaging device 20 mounted on a drone, or a tablet device that is portable by a human.

The measurement device 30 comprises a computer including one or more sensors. Sensors include, but are not limited to, digital tachographs, tire pressure monitoring systems (TPMS), electronic control units (ECU), car navigation devices, and the like.

For example, measurement data for the tire 2 mounted on the vehicle 3 includes tire condition data for the tire 2. Tire condition data includes, but is not limited to, for example, internal pressure (air pressure), cavity temperature, thermal history, and the like for the tire 2. The thermal history of the tire 2 is the history of heat applied to the tire 2 as the tire 2 is used. The thermal history of the tire 2 is used to evaluate how much energy has been applied to the tire 2 since the beginning of use of the tire 2. Typically, the greater the thermal history, the more the tire 2 deteriorates. The thermal history can be calculated, for example, by applying the cavity temperature of the tire 2 to the Arrhenius equation. Further, the measurement data regarding the tire 2 mounted on the vehicle 3 includes travel data of the vehicle 3. Travel data of the vehicle 3 includes, but is not limited to, for example, running time, running distance, speed, acceleration of the vehicle 3, and number of revolutions of the tire 2. The measurement data regarding the tire 2 mounted on the vehicle 3 may be time-series data including each measurement value and a corresponding measurement date and time.

The measurement device 30 measures and transmits measurement data regarding the tire 2 mounted on the vehicle 3 to the server 10. Therefore, the measurement device 30 may be disposed in the vehicle 3 or the tire 2.

The terminal device 40 is a computer, such as a smartphone, tablet device, personal computer, or the like.

The network 50 is any communication network that allows the server 10, the imaging devices 20, the measurement device 30, and the terminal device 40 to communicate with each other. The network 50 according to the present embodiment may be, for example, the Internet, a mobile communication network, a local area network (LAN), or a combination of these.

The tire outer-damage monitoring system 1 is used to monitor the outer-damage of one or more of the tires 2. In the tire outer-damage monitoring system 1, the server 10 acquires the image 60 of the tire 2 from, for example, the imaging device 20. The server 10 then quantifies the degree of outer-damage on an outer surface of the tire 2 as captured in the image 60. The server 10 determines whether the degree of outer-damage is outside a tolerance range of durability of the tire 2, and on determining that the degree of outer-damage is outside the tolerance range, the server 10 outputs outer-damage information on the tire 2. For example, the outer-damage information on the tire 2 may be transmitted from the server 10 to the terminal device 40 and displayed by the terminal device 40. Thus, according to the tire outer-damage monitoring system 1, the server 10 can automatically monitor outer-damage on the outer surface of the tire 2 based on the image 60 acquired from the imaging device 20, and output outer-damage information on the tire 2 according to the degree of outer-damage.

In the present disclosure, the tire 2 is not particularly limited. The tire 2 may be an off-the-road (OR) tire mounted to a mine vehicle such as a transport vehicle, a construction vehicle, an engineering vehicle, a heavy equipment vehicle, or the like used at a mine site or the like. However, the tire 2 may be a tire other than an OR tire.

Further, in the present disclosure, the vehicle 3 is a mine vehicle used, for example, at a mine site or the like. However, the vehicle 3 is not limited to the mine vehicles mentioned above, and may be any vehicle on which the tire 2 can be mounted, such as a transport vehicle, a construction vehicle, an engineering vehicle, a heavy equipment vehicle, a bus, a passenger vehicle, a motorcycle, a bicycle, an airplane, or the like.

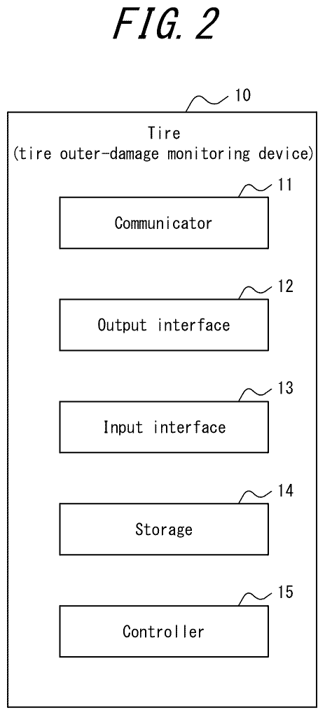

The following is a detailed description of configuration of the server 10, the tire outer-damage monitoring device, with reference to FIG. 2. FIG. 2 is a block diagram illustrating configuration of the server 10. As illustrated in FIG. 2, the server device 10 includes a communicator 11, an output interface 12, an input interface 13, a storage 14, and a controller 15. In the server 10, the communicator 11, the output interface 12, the input interface 13, the storage 14, and the controller 15 are wired or wirelessly communicatively connected to each other.

The communicator 11 includes a communication module for connection to the network 50. The communication module is, for example, a communication module compatible with mobile communication standards such as 4G (4th Generation), 5G (5th Generation), and the like. The communication module may be, for example, a communication module that supports standards such as wired LAN, wireless LAN, and the like. The communication module may be a communication module compatible with Wi-Fi® (Wi-Fi is a registered trademark in Japan, other countries, or both), Bluetooth® (Bluetooth is a registered trademark in Japan, other countries, or both), or near field communication such as infrared communication. According to the present embodiment, the server 10 is connected to the network 50 via the communicator 11. This allows the server 10 to communicate with the imaging devices 20, the measurement device 30, the terminal device 40, another computer, and the like.

The output interface 12 includes one or more output devices. Output devices are, for example, displays, speakers, lamps, and the like. As a result, the output interface 12 outputs an image, sound, light, or the like.

The input interface 13 includes one or more input devices. Input devices are, for example, touch panels, cameras, microphones, and the like. The input interface 13, for example, accepts input operations by a user of the server 10.

The storage 14 is, for example, semiconductor memory, magnetic memory, optical memory, or the like. The storage 14 functions, for example, as a main storage device, auxiliary storage device, or cache memory. The storage 14 stores any information used in operation of the server 10. The storage 14 may store a system program, an application program, embedded software, a database, and the like. The information stored in the storage 14 may be updatable with information obtained from the network 50 via the communicator 11, for example.

For example, the storage 14 may store tire identification information of one or more of the tires 2 subject to outer-damage monitoring. Tire identification information of the tire 2 is information that uniquely identifies the tire 2. Tire identification information is, for example, an identifier (ID) of the tire 2 uniquely assigned by the server 10, but is not limited to this example and may be a serial number of the tire 2, a vehicle number of the vehicle 3 on which the tire 2 is mounted, or the like. Further, the storage 14 may store information regarding the tire 2 in association with tire identification information on the tire 2.

Information regarding the tire 2 includes, for example, at least one of the following: outer-damage information on the tire 2, measurement data regarding the tire 2, configuration information on the tire 2, information on the vehicle 3 on which the tire 2 is mounted, or position information on where the tire 2 is mounted on the vehicle 3. Outer-damage information on the tire 2 may be, for example, time series data including location, shape, depth, and recorded date and time of outer-damage that the tire 2 has suffered in the past. Configuration information on the tire 2 includes, for example, type of the tire 2, model number, material properties, tread pattern, belt angle, size, weight, and the like. Information on the vehicle 3 on which the tire 2 is mounted includes identification information of the vehicle 3, type, model number, engine displacement, number of tires mounted, number of shafts, and the like.

The controller 15 includes one or more processors. Each processor may be, for example, a general-purpose processor such as a central processing unit (CPU), or a dedicated processor specialized for a particular process. The controller 15 is not limited to processors and may include one or more dedicated circuits. Each dedicated circuit may be, for example, a field-programmable gate array (FPGA) or an application specific integrated circuit (ASIC). The controller 15 controls each of the components to realize the functions of the server 10, including the functions of components such as the communicator 11, the output interface 12, the input interface 13, and the storage 14, as described above.

### Operation of Tire Outer-Damage Monitoring System

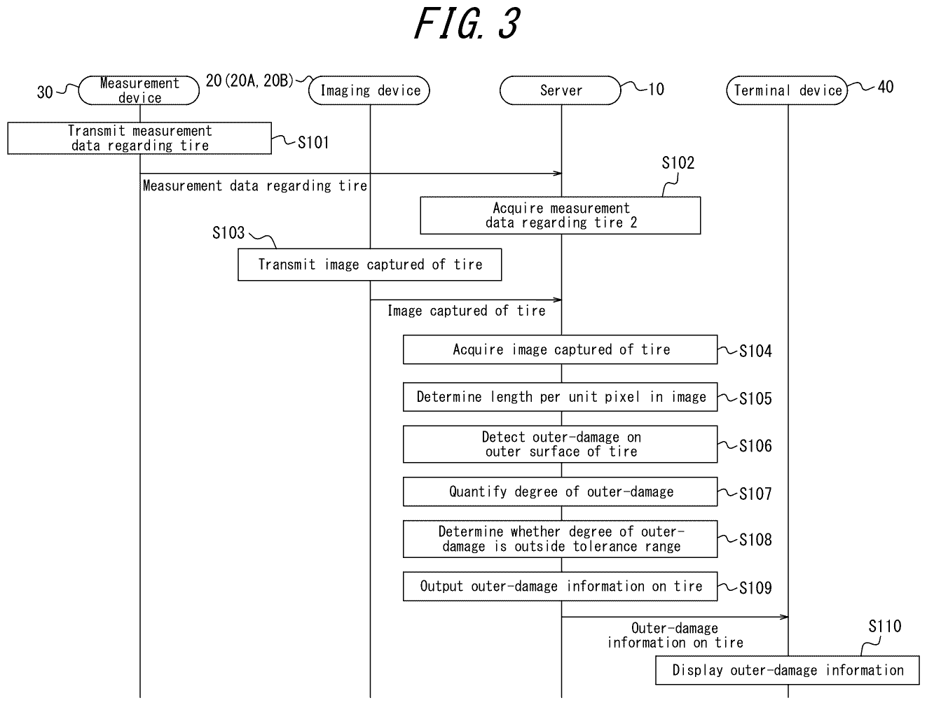

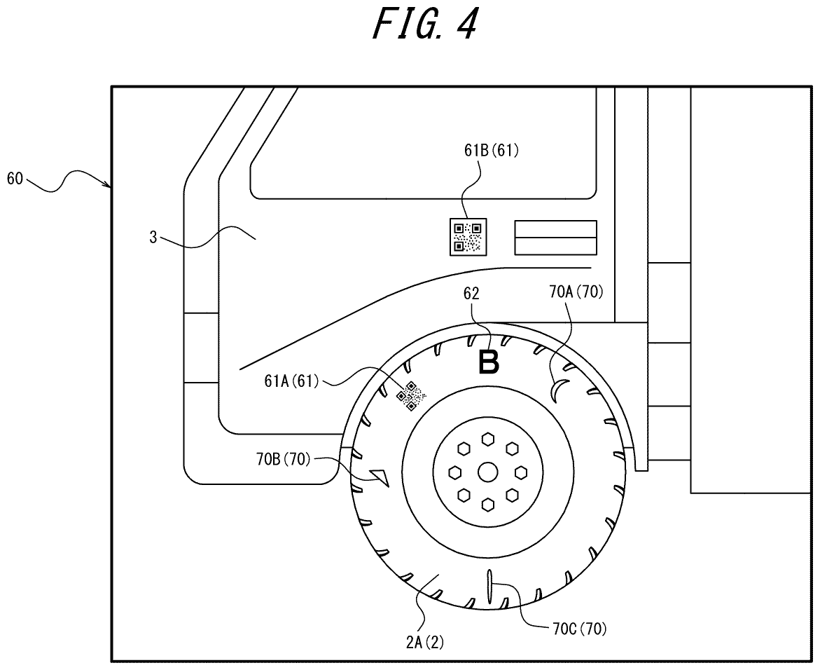

Referring to FIG. 3 and FIG. 4, operation of the tire outer-damage monitoring system 1 is described. FIG. 3 is a flowchart illustrating operation of the tire outer-damage monitoring system 1. FIG. 4 is a diagram illustrating an example of the image 60 of the tire 2. The flowchart illustrated in FIG. 3 illustrates operation of the server 10, the imaging devices 20, the measurement device 30, and the terminal device 40 included in the tire outer-damage monitoring system 1. Therefore, the description of this operation corresponds to the tire outer-damage monitoring method executed by the tire outer-damage monitoring system 1, and the tire outer-damage monitoring method executed by each of the server 10, the imaging devices 20, the measurement device 30, and the terminal device 40 included in the tire outer-damage monitoring system 1.

In describing this operation, it is assumed that the controller 15 of the server 10 stores in the storage 14 the tire identification information of the tire 2 and the information regarding the tire 2 associated with the tire identification information of the tire 2.

Further, as an example, the operation example describes an operation in which the server 10 detects outer-damage 70 on an outer surface of a side portion 2A of the tire 2, based on the image 60 illustrated in FIG. 4. In such a case, the imaging device 20 may be disposed in a position where a side surface of the vehicle 3 can be captured. The imaging device 20 may be the imaging device 20A disposed at a point of severe conditions putting a large load on the tire 2, or may be the imaging device 20B disposed at a point of mild conditions putting a small load on the tire 2. Preferably, the tire outer-damage monitoring system 1 includes, as the imaging device 20, the imaging device 20A installed at a point of severe conditions. More preferably, the tire outer-damage monitoring system 1 includes, as the imaging devices 20, both the imaging device 20A installed at a point of severe conditions and the imaging device 20B installed at a point of mild conditions.

Referring to FIG. 3, in step S101, the measurement device 30 transmits to the server 10 the measurement data regarding the tire 2 measured using a sensor.

Specifically, the measurement device 30 uses a sensor to measure measurement data regarding the tire 2. The measurement device 30 may transmit measurement data regarding the tire 2 to the server 10 each time measurement data regarding the tire 2 is measured, and may transmit all measurement data regarding the tire 2 measured during a defined period of time to the server 10 at once. In this operation example, the measurement device 30 includes a digital tachograph and TPMS. Therefore, the measurement data regarding the tire 2 includes tire condition data of the tire 2, such as internal pressure (air pressure), cavity temperature, and thermal history of the tire 2, and travel data of the vehicle 3, such as running time and running distance of the vehicle 3. However, the measurement data transmitted from the measurement device 30 may include data other than the data described above.

In step S102, the controller 15 of the server 10 acquires the measurement data regarding the tire 2.

Specifically, the controller 15 of the server 10 receives the measurement data regarding the tire 2 from the measurement device 30 via the communicator 11. However, the controller 15 may receive measurement data regarding the tire 2 measured by the measurement device 30 via a computer other than the measurement device 30. The controller 15 may store the received measurement data regarding the tire 2 in the storage 14 in association with identification information of the tire 2.

In step S103, the imaging device 20 transmits to the server 10 the image 60 of the tire 2 captured by a camera.

Specifically, the imaging device 20 uses a camera to image capture the tire 2 and generate the image 60 of the tire 2. The image 60 is preferably a plurality of still images captured continuously or a moving image. However, the image 60 may be a single still image. In this operation example, the imaging devices 20 include a thermographic camera and a visible light camera. Therefore, as the image 60, a thermographic image captured by the thermographic camera and a photograph captured by the visible light camera are transmitted. However, the image transmitted from the imaging device 20 is not limited to these examples. Further, in addition to at least a portion of the tire 2, the image 60 of the tire 2 may also capture a portion of the vehicle 3 on which the tire 2 is mounted. In this operation example, as an example of a photograph, the image 60 illustrated in FIG. 4 is transmitted from the image capture device 20 to the server 10. The image 60 captures the tire 2 and a portion of the vehicle 3 on which the tire 2 is mounted.

Referring again to FIG. 3, in step S104, the controller 15 of the server 10 acquires the image 60 of the tire 2.

Specifically, the controller 15 of the server 10 receives the image 60 of the tire 2 from the imaging device 20 via the communicator 11. However, the controller 15 may receive the image 60 captured by the imaging device 20 via a computer other than the imaging device 20. The controller 15 may store the received image 60 in the storage 14 in association with identification information of the tire 2.

In step S104, further, the controller 15 of the server 10 may specify identification information of the tire 2 that is displayed on the tire 2 or on the vehicle 3 on which the tire 2 is mounted, as captured in the image 60. This allows the controller 15 to identify the tire 2 from the image 60, even when the tire 2 captured in the image 60 has not been identified in advance. Specifically, the controller 15 uses image processing to specify a display portion 61 that indicates identification information of the tire 2 in the image 60. As illustrated in FIG. 4, the display portion 61 may be a two-dimensional code, such as a QR Code® (quick response code; QR Code is a registered trademark in Japan, other countries, or both), an augmented reality (AR) marker, or the like. In such a case, the controller 15 can read the identification information of the tire 2 from the display portion 61 that is a two-dimensional code. However, the display portion 61 is not limited to being a two-dimensional code, and may be any display, including a character string, a symbol, a figure, a color, a pattern, a one-dimensional code, and the like.

The display portion 61 indicating the identification information of the tire 2 may be displayed in any position. For example, in FIG. 4, display portions 61A and 61B are illustrated. The display portion 61A is located on the side portion 2A of the tire 2. In such a case, even when the tire 2 is mounted on another of the vehicle 3 due to tire rotation or the like, the identification information of the tire 2 can be specified based on the display portion 61. The display portion 61B is located on a body of the vehicle 3 on which the tire 2 is mounted. In such a case, even when the outer surface of the tire 2 is dirty with mud or damaged, the display portion 61 being located on the body of the vehicle 3 makes a decrease in the visibility of the display portion 61 less likely.

Referring again to FIG. 3, in step S105, the controller 15 of the server 10 determines the actual length per unit pixel in the image 60.

Any method can be employed to determine the actual length per unit pixel. For example, the controller 15 of the server 10 may store in the storage 14 the actual length per unit pixel in the image 60 to calculate the actual length of an object captured in the image 60.

Alternatively, the controller 15 of the server 10 may store in the storage 14 a reference member 62 associated with the tire 2 used for such determination. The reference member 62 associated with the tire 2 may be a groove, a character, a symbol, a shape, a color, or a pattern on the outer surface of the tire 2. In the example illustrated in FIG. 4, the reference member 62 is a character on the outer surface of the side portion 2A of the tire 2. The controller 15 may determine the actual length per unit pixel in the image 60 based on the actual length of the reference member 62 associated with the tire 2 and the length of the reference member 62 as captured in the image 60.

For example, the controller 15 of the server 10 specifies an outline of the reference member 62 that is captured in the image 60. The controller 15 specifies a distance between the two most distant points of the specified outline of the reference member 62 as the length of the reference member 62 captured in the image 60. The length of the reference member 62 captured in the image 60 may be expressed in pixels. The controller 15 can determine the actual length per unit pixel in the image 60 from the number of pixels corresponding to the length of the reference member 62 captured in the image 60 and the actual length of the reference member 62 associated with the tire 2. This improves the precision of estimating the size or depth of the outer-damage 70 of the tire 2 in subsequent processing. However, the reference member 62 may be the rim of the tire 2. In such a case, the length of the reference member 62 may be, for example, the rim diameter of the tire 2.

Referring again to FIG. 3, in step S106, the controller 15 of the server 10 detects the outer-damage 70 on the outer surface of the tire 2 that is captured in the image 60.

Any method can be employed to detect the outer-damage 70. For example, the controller 15 of the server 10 may store in advance, in the storage 14, an image analysis algorithm for specifying the outer-damage 70 of the tire 2 captured in the image 60.

For example, when the image 60 is a photograph, the controller 15 of the server 10 may use an image analysis algorithm to detect an outline of the outer-damage 70 such as a cut or crack on the outer surface of the tire 2 that is captured in the image 60. In the example illustrated in FIG. 4, the controller 15 can detect the three outlines of the outer-damage 70A, 70B, and 70C on the outer surface of the tire 2. The controller 15 may store information, such as the location and count of the outer-damage 70A, 70B, and 70C detected, in the storage 14, in association with the identification information of the tire 2, as outer-damage information on the tire 2. In the following description, when the outer-damage 70A, 70B, and 70C is not specifically distinguished, it may be referred to simply as the outer-damage 70.

For example, when the image 60 is a thermographic image, the controller 15 of the server 10 may use an image analysis algorithm to detect portions of the outer surface of the tire 2 that indicate higher temperatures than other portions in the image 60 as the outer-damage 70, such as cuts or cracks. For example, a portion that is at least 5 degrees hotter than the surrounding portion may be detected as the outer-damage 70. The controller 15 may store information, such as the location and count of the outer-damage 70 detected, in the storage 14, in association with the identification information of the tire 2, as outer-damage information on the tire 2. Typically, cavity temperature of the tire 2 increases as the vehicle 3 travels. The outer-damage 70 on the outer surface of tire 2 is closer to the cavity of the tire 2 than other portions of the tire, resulting in a higher surface temperature. Thus, the thermographic image can be used to detect the location, depth, and the like, of the outer-damage 70 on the outer surface of the tire 2. By using a thermographic image, the precision of detection of outer-damage of the tire 2 is less likely to decrease when the outer surface of the tire 2 is image captured when dirty with mud or the like, or even when the tire 2 is image captured at night.

According to the present embodiment, an image analysis algorithm may be constructed by a statistical method such as machine learning or deep learning. For example, an image analysis algorithm may be constructed by a statistical method, using as labeled data the image 60 of the tire 2 and the outer-damage 70 of the tire 2 specified by a human or otherwise. This allows the accumulation of labeled data to improve the detection precision of the outer-damage 70 on the outer surface of the tire 2. However, the image analysis algorithm may include defined arithmetic processing that is not based on a statistical method.

Referring again to FIG. 3, in step S107, the controller 15 of the server 10 quantifies the degree of the outer-damage 70 on the outer surface of the tire 2 as captured in the image 60.

Any method can be employed to quantify the degree of the outer-damage 70. For example, when the image 60 is a photograph, the controller 15 of the server 10 may estimate the depth of the outer-damage 70 from at least one of the length or width of the outer-damage 70 of the tire 2 in the image 60. The controller 15 may store in advance, in the storage 14, a mapping algorithm for estimating the depth of the outer-damage 70 from at least one of the length or width of the outer-damage 70 of the tire 2. The controller 15 may take the distance between the two most distant points of the outline of the outer-damage 70 specified in step S106 as the length, and the distance between the two most distant points in the direction orthogonal to the length direction as the width. The controller 15 may use the actual length per unit pixel in the image 60 calculated in step S105 when calculating the length and width of the outer-damage 70. The controller 15 then estimates the depth of the outer-damage 70 from at least one of the length or the width of the outer-damage 70 using a mapping algorithm. The depth of the outer-damage 70 is, for example, the distance from the outer surface of the tire 2 to the deepest portion of the outer-damage 70. The controller 15 may store the depth of the outer-damage 70 as estimated in the storage 14 in association with the identification information of the tire 2 as outer-damage information on the tire 2. When there is more than one of the outer-damage 70, the deepest depth of the plurality of the outer-damage 70 may be considered the depth of the outer-damage 70 of the tire 2 in subsequent processing.

For example, when the image 60 is a thermographic image, the controller 15 of the server 10 may estimate the depth of the outer-damage 70 from the temperature of the outer-damage 70 on the outer surface of the tire 2 as captured in the image 60. The controller 15 may store in advance, in the storage 14, a mapping algorithm for estimating the depth of the outer-damage 70 from the temperature of the outer-damage 70 on the outer surface of the tire 2. The controller 15 estimates the depth of the outer-damage 70 from the temperature of the outer-damage 70 using a mapping algorithm. The depth of the outer-damage 70 is, for example, the depth corresponding to the highest temperature portion of the temperature of the outer-damage 70 of the tire 2. In addition to the temperature of the outer-damage 70 on the outer surface of the tire 2, the controller 15 may estimate the depth of the outer-damage 70 using the cavity temperature of the tire 2, included in the measurement data regarding the tire 2 obtained from the measurement device 30. As noted above, the temperature of the outer-damage 70 on the outer surface of the tire 2 is affected by the temperature of the cavity of the tire 2, and therefore the precision of estimating the depth of the outer-damage 70 can be improved by using the relative difference between the temperature of the outer-damage 70 and the cavity temperature of the tire 2. The controller 15 may store the depth of the outer-damage 70 as estimated in the storage 14 in association with the identification information of the tire 2 as outer-damage information on the tire 2. When there is more than one of the outer-damage 70, the highest temperature of the temperature of the plurality of the outer-damage 70 may be used as the temperature of the outer-damage 70 of the tire 2 in subsequent processing.

According to the present embodiment, a mapping algorithm may be constructed by a statistical method such as machine learning or deep learning. For example, a mapping algorithm may be constructed by a statistical method, using as labeled data the properties of the outer-damage 70 of the tire 2 and the depth of the outer-damage 70 measured by a human or otherwise. This allows the accumulation of labeled data to improve the precision of estimating the depth of the outer-damage 70 of the tire 2. However, the mapping algorithm may include defined arithmetic processing that is not based on a statistical method.

The controller 15 of the server 10 may measure the count, size (area of the portion surrounded by an outline of the outer-damage 70 on the outer surface of the tire 2) of the outer-damage 70, or the like, in addition to or instead of the depth of the outer-damage 70 on the outer surface of the tire 2, as a quantification of the degree of the outer-damage 70. The controller 15 may store the count or size of the outer-damage 70 as measured in the storage 14 in association with the identification information of the tire 2 as outer-damage information on the tire 2.

In step S108, the controller 15 of the server 10 determines whether the degree of outer-damage 70 of the tire 2 is outside the tolerance range of the durability of the tire 2.

The tolerance range of the durability of the tire 2 may be determined arbitrarily. For example, the tolerance range of the durability of the tire 2 may be determined according to the depth, count, size, or temperature of the outer-damage 70, as described above, as the degree of the outer-damage 70 of the tire 2. Alternatively, the tolerance range of the durability of the tire 2 may be determined according to two or more of the following: depth, count, size, or temperature of the outer-damage 70. The controller 15 of the server 10 may determine, for example, that the degree of the outer-damage 70 of the tire 2 is outside the tolerance range of the durability of the tire 2 when the depth, count, size, or temperature of the outer-damage 70 is greater than a value determined as the tolerance range of the durability of the tire 2.

Further, the tolerance range of the durability of the tire 2 may be determined in composite, using other elements in addition to the degree of the outer-damage 70 of the tire 2. Other elements may be, for example, information included in the measurement data regarding the tire 2 acquired from the measurement device 30. As an example, the controller 15 of the server 10 may determine whether the degree of the outer-damage 70 is outside the tolerance range of the durability of the tire 2 based on the degree of the outer-damage 70 of the tire 2 and the running distance or running time of the vehicle 3 on which the tire 2 is mounted. Specifically, when the extent of the outer-damage 70 of the tire 2 is large despite a small running distance or running time of the vehicle 3, the outer-damage 70 is considered to be progressing quickly. Therefore, the tolerance range may be set such that the greater the degree of the outer-damage 70 of the tire 2 and the less the running distance or running time of the vehicle 3 on which the tire 2 is mounted, the more likely the degree of the outer-damage 70 is to exceed the tolerance range. This can improve the precision of determining whether the outer-damage 70 of the tire 2 exceeds the tolerance range of the durability of the tire 2.

As another example, the controller 15 of the server 10 may determine whether the degree of the outer-damage 70 is outside the tolerance range of the durability of the tire 2 based on the degree of the outer-damage 70 and the thermal history of the tire 2. Specifically, when the thermal history of the tire 2 is large, the tire 2 has already deteriorated and the outer-damage 70 of the tire 2 is likely to progress quickly. Therefore, the tolerance range may be set such that the greater the degree of the outer-damage 70 of the tire 2 and the greater the thermal history of the tire 2, the more likely the degree of the outer-damage 70 is to exceed the tolerance range. This can improve the precision of determining whether the outer-damage 70 of the tire 2 exceeds the tolerance range of the durability of the tire 2.

Further, in step S108, the controller 15 of the server 10 may determine whether the degree of the outer-damage 70 of the tire 2 is outside the tolerance range of the durability of the tire 2 based on a plurality of degrees of the outer-damage 70 of the tire 2 quantified based on the image 60 of the tire 2 captured under different conditions.

Specifically, the controller 15 of the server 10 quantifies the degree of the outer-damage 70 (first outer-damage) of the tire 2 based on the image 60 (first image) captured by the imaging device 20A under severe conditions putting a large load on the tire 2. Further, the controller 15 quantifies the degree of the outer-damage 70 (second outer-damage) of the tire 2 based on the image 60 (second image) captured by the imaging device 20B under mild conditions putting a small load on the tire 2. The controller 15 may determine whether the degree of the outer-damage 70 of the tire 2 is outside the tolerance range of the durability of the tire 2 based on these two degrees of the outer-damage 70 of the tire 2. Specifically, at one mine site under severe conditions, when compared to mild conditions, when an opening-state of the outer-damage 70 of the tire 2 is much larger, or when the temperature of the outer-damage 70 of the tire 2 is higher, the outer-damage 70 of the tire 2 is considered to be progressing faster at the one mine site. In such a case, the type of the tire 2 used at the one mine site could be changed. Thus, the determination described above can improve the precision of determining whether the outer-damage 70 of the tire 2 exceeds the tolerance range of the durability of the tire 2.

The tolerance range of the durability of the tire 2 may be set to a plurality of levels. For example, the tolerance range of the durability of the tire 2 may be set to levels, such as a level at which the tire 2 needs to be replaced immediately, a level at which the tire 2 needs to be replaced within one month, a level at which the tire 2 needs to be replaced within two months, and the like.

In step S109, the controller 15 of the server 10 outputs the outer-damage information on the tire 2 on determining that the outer-damage 70 of the tire 2 is outside the tolerance range.

Any method may be employed to output the outer-damage information on the tire 2. For example, the controller 15 of the server 10 may display the outer-damage information on the tire 2 via the output interface 12, such as a display. The controller 15 may transmit a request via the communicator 11 to the terminal device 40 to display the outer-damage information on the tire 2. In such a case, the terminal device 40 can display the outer-damage information on the tire 2 via a display or the like based on the request received from the server 10 in step S110. The outer-damage information on the tire 2 includes, for example, the degree of the outer-damage 70 of the tire 2. However, the outer-damage information on the tire 2 is not limited to the degree of the outer-damage 70 of the tire 2, and may include any information, such as content of the tolerance range that the degree of the outer-damage 70 is outside, a warning message, and the like. As a result, a user of the tire outer-damage monitoring system 1 can easily ascertain the degree of the outer-damage 70 on the outer surface of the tire 2 and plan for inspection, repair, replacement, and the like for the tire 2 before failure of the tire 2. In particular, when the tire 2 is replaced, the tire 2 may be replaced with a different tire 2 depending on the outer-damage information on the tire 2. For example, the tire 2 may be replaced with another type of the tire 2 having a higher heat resistance when the temperature of the outer-damage 70 is higher than a temperature endurance set for the tire 2. The tire 2 may be replaced with another type of the tire 2 that is less prone to the outer-damage 70 when the count of the outer-damage 70 is greater than a defined number. In this way, a user of the tire outer-damage monitoring system 1 can adopt the tire 2 that is suitable for use at a mine site, based on the outer-damage information on the tire 2.

As described above, according to the present embodiment, the server 10, which is a tire outer-damage monitoring device, acquires the image 60 of the tire 2. The server 10 then quantifies the degree of outer-damage on an outer surface of the tire 2 as captured in the image 60. The server 10 determines whether the degree of the outer-damage 70 is outside the tolerance range of the durability of the tire 2, and on determining that the degree of the outer-damage 70 is outside the tolerance range, the server 10 outputs the outer-damage information on the tire 2.

According to such a configuration, the server 10 can automatically monitor the outer-damage 70 on the outer surface of the tire 2 based on the image 60 acquired and output the outer-damage information on the tire 2 according to the degree of the outer-damage 70. This can decrease a loss of productivity caused by sudden failure of the tire 2 at a mine site and can suppress an increase in worker workload for inspection of the tire 2. Thus, according to the present embodiment, the usefulness of technology for monitoring outer-damage of the tire 2 can be improved.

In the operation example described above, operation of the tire outer-damage monitoring system 1 to detect the outer-damage 70 on the outer surface of the side portion of the tire 2 is described, but this is not a limitation. The outer surface of the tire 2 as an object of processing by the tire outer-damage monitoring system 1 may include at least one of the outer surface of the side portion or the outer surface of the tread portion of the tire 2. In other words, the tire outer-damage monitoring system 1 may be used to detect the outer-damage 70 on the outer surface of the tread portion of the tire 2 in addition to or instead of the side portion of the tire 2. In such a case, the imaging device 20 may be disposed in a position that allows image capture of the front or rear of the vehicle 3 in order to capture the tread portion of the tire 2. Then, similar to the operation example described above, the server 10 acquires the image 60 of the tread portion of the tire 2 from the imaging device 20. The server 10 then quantifies the degree of the outer-damage on an outer surface of the tread portion of the tire 2 as captured in the image 60. The server 10 determines whether the degree of the outer-damage 70 is outside the tolerance range of the durability of the tire 2, and on determining that the degree of the outer-damage 70 is outside the tolerance range, the server 10 outputs the outer-damage information on the tire 2. This allows the server 10 to monitor the outer-damage 70 on the outer surface of the tread portion of the tire 2 in addition to or instead of the side portion of the tire 2.

Although the present disclosure has been described based on the drawings and embodiments, it should be noted that a person skilled in the art may make variations and modifications based on the present disclosure. Therefore, it should be noted that such variations and modifications are included within the scope of the present disclosure. For example, the configurations, functions, or the like included in each embodiment may be rearranged as long as no logical inconsistency arises. The configurations, functions, or the like included in each embodiment may be used in combination with other embodiments, and multiple configurations, functions, or the like may be combined, divided, or partially omitted.

Further, for example, an embodiment is possible in which a general-purpose computer functions as the server 10 according to a disclosed embodiment. Specifically, a program describing processing content to realize each function of the server 10 according to a disclosed embodiment is stored in memory of the general-purpose computer, and the program is read and executed by a processor. Therefore, a disclosed embodiment may also be realized as a program executable by a processor or a non-transitory computer-readable medium storing the program. The non-transitory computer-readable medium includes, for example, a magnetic recording device, an optical disk, a magneto-optical recording medium, semiconductor memory, and the like.

### INDUSTRIAL APPLICABILITY

According to the present disclosure, the tire outer-damage monitoring device and the tire outer-damage monitoring method can be provided that can improve the usefulness of the technology for monitoring tire outer-damage.

### REFERENCE SIGNS LIST

1: tire outer-damage monitoring system, 2: tire, 2A: side portion, 3: vehicle, 10: server (tire outer-damage monitoring device), 11: communicator, 12: output interface, 13: input interface, 14: storage, 15: controller, 20: imaging device, 30: measurement device, 40: terminal device, 50: network, 60: image, 61 (61A, 61B): display portion, 62: reference member, 70: outer-damage

1. A tire outer-damage monitoring device comprising
a controller configured to execute:
acquiring an image of a tire;
quantifying a degree of outer-damage on an outer surface of the tire as captured in the image;
determining whether the degree of the outer-damage is outside a tolerance range of durability of the tire; and
on determining that the degree of the outer-damage is outside the tolerance range, outputting outer-damage information on the tire.

2. The tire outer-damage monitoring device according to claim 1, wherein the quantifying of the degree of the outer-damage includes estimating depth of the outer-damage from at least one of length or width of the outer-damage on the outer surface of the tire as captured in the image.

3. The tire outer-damage monitoring device according to claim 1, wherein the image includes a thermographic image captured by a thermal imaging camera, and
the quantifying of the degree of the outer-damage includes estimating depth of the outer-damage from temperature of the outer-damage on the outer surface of the tire as captured in the thermographic image.

4. The tire outer-damage monitoring device according to claim 3, wherein the controller is further configured to execute:
acquiring cavity temperature of the tire; and
estimating the depth of the outer-damage using the cavity temperature of the tire in addition to the temperature of the outer-damage on the outer surface of the tire as captured in the image.

5. The tire outer-damage monitoring device according to claim 1, wherein the controller is further configured to execute:
acquiring running distance or running time of a vehicle on which the tire is mounted; and
determining whether the degree of the outer-damage is outside the tolerance range of the durability of the tire based on the degree of the outer-damage and the running distance or running time of the vehicle, wherein
the tolerance range is set such that the greater the degree of the outer-damage and the less the running distance or the running time of the vehicle, the more likely the degree of the outer-damage exceeds the tolerance range.

6. The tire outer-damage monitoring device according to claim 1, wherein the controller is further configured to execute:
acquiring thermal history of the tire; and
determining whether the degree of the outer-damage is outside the tolerance range of the durability of the tire based on the degree of the outer-damage and the thermal history of the tire, wherein
the tolerance range is set such that the greater the degree of the outer-damage and the greater the thermal history, the more likely the degree of the outer-damage exceeds the tolerance range.

7. The tire outer-damage monitoring device according to claim 1, wherein the image of the tire includes a first image captured under severe conditions putting a large load on the tire and a second image captured under mild conditions putting a small load on the tire, and
the controller is configured to execute:
determining whether the degree of the outer-damage of the tire is outside the tolerance range of the durability of the tire based on a first degree of outer-damage quantified based on the first image and a second degree of outer-damage quantified based on the second image.

8. A tire outer-damage monitoring method executed by one or more computers, the tire outer-damage monitoring method comprising:
acquiring an image of a tire;
quantifying a degree of outer-damage on an outer surface of the tire as captured in the image;
determining whether the degree of the outer-damage is outside a tolerance range of durability of the tire; and
on determining that the degree of the outer-damage is outside the tolerance range, outputting outer-damage information on the tire.

9. The tire outer-damage monitoring device according to claim 2, wherein the controller is further configured to execute:
acquiring running distance or running time of a vehicle on which the tire is mounted; and
determining whether the degree of the outer-damage is outside the tolerance range of the durability of the tire based on the degree of the outer-damage and the running distance or running time of the vehicle, wherein
the tolerance range is set such that the greater the degree of the outer-damage and the less the running distance or the running time of the vehicle, the more likely the degree of the outer-damage exceeds the tolerance range.

10. The tire outer-damage monitoring device according to claim 2, wherein the controller is further configured to execute:
acquiring thermal history of the tire; and
determining whether the degree of the outer-damage is outside the tolerance range of the durability of the tire based on the degree of the outer-damage and the thermal history of the tire, wherein
the tolerance range is set such that the greater the degree of the outer-damage and the greater the thermal history, the more likely the degree of the outer-damage exceeds the tolerance range.

11. The tire outer-damage monitoring device according to claim 2, wherein the image of the tire includes a first image captured under severe conditions putting a large load on the tire and a second image captured under mild conditions putting a small load on the tire, and
the controller is configured to execute:
determining whether the degree of the outer-damage of the tire is outside the tolerance range of the durability of the tire based on a first degree of outer-damage quantified based on the first image and a second degree of outer-damage quantified based on the second image.

12. The tire outer-damage monitoring device according to claim 3, wherein the controller is further configured to execute:
acquiring running distance or running time of a vehicle on which the tire is mounted; and
determining whether the degree of the outer-damage is outside the tolerance range of the durability of the tire based on the degree of the outer-damage and the running distance or running time of the vehicle, wherein
the tolerance range is set such that the greater the degree of the outer-damage and the less the running distance or the running time of the vehicle, the more likely the degree of the outer-damage exceeds the tolerance range.

13. The tire outer-damage monitoring device according to claim 3, wherein the controller is further configured to execute:
acquiring thermal history of the tire; and
determining whether the degree of the outer-damage is outside the tolerance range of the durability of the tire based on the degree of the outer-damage and the thermal history of the tire, wherein
the tolerance range is set such that the greater the degree of the outer-damage and the greater the thermal history, the more likely the degree of the outer-damage exceeds the tolerance range.

14. The tire outer-damage monitoring device according to claim 3, wherein the image of the tire includes a first image captured under severe conditions putting a large load on the tire and a second image captured under mild conditions putting a small load on the tire, and
the controller is configured to execute:
determining whether the degree of the outer-damage of the tire is outside the tolerance range of the durability of the tire based on a first degree of outer-damage quantified based on the first image and a second degree of outer-damage quantified based on the second image.

15. The tire outer-damage monitoring device according to claim 4, wherein the controller is further configured to execute:
acquiring running distance or running time of a vehicle on which the tire is mounted; and
determining whether the degree of the outer-damage is outside the tolerance range of the durability of the tire based on the degree of the outer-damage and the running distance or running time of the vehicle, wherein
the tolerance range is set such that the greater the degree of the outer-damage and the less the running distance or the running time of the vehicle, the more likely the degree of the outer-damage exceeds the tolerance range.

16. The tire outer-damage monitoring device according to claim 4, wherein the controller is further configured to execute:
acquiring thermal history of the tire; and
determining whether the degree of the outer-damage is outside the tolerance range of the durability of the tire based on the degree of the outer-damage and the thermal history of the tire, wherein
the tolerance range is set such that the greater the degree of the outer-damage and the greater the thermal history, the more likely the degree of the outer-damage exceeds the tolerance range.

17. The tire outer-damage monitoring device according to claim 4, wherein the image of the tire includes a first image captured under severe conditions putting a large load on the tire and a second image captured under mild conditions putting a small load on the tire, and
the controller is configured to execute:
determining whether the degree of the outer-damage of the tire is outside the tolerance range of the durability of the tire based on a first degree of outer-damage quantified based on the first image and a second degree of outer-damage quantified based on the second image.
